(19) United States
(12) Patent Application Publication
(10) Pub. No.: US 2016/0122235 A1
(43) Pub. Date: May 5, 2016

(54) Low-E Panels and Methods of Forming the Same

(71) Applicant: Intermolecular Inc., San Jose, CA (US)

(72) Inventors: Guizhen Zhang, Santa Clara, CA (US); Guowen Ding, San Jose, CA (US); Tong Ju, Santa Clara, CA (US); Minh Huu Le, San Jose, CA (US); Daniel Schweigert, Fremont, CA (US)

(21) Appl. No.: 14/531,643

(22) Filed: Nov. 3, 2014

(51) Int. Cl. C03C 17/36

(52) U.S. Cl. CPC C03C 17/366; C03C 17/3618; C03C 17/3639; C03C 17/3626; C03C 17/3642; C03C 2218/155

(57) ABSTRACT

Embodiments provided herein describe low-e panels and methods for forming low-e panels. A transparent substrate is provided. A first dielectric layer is formed above the transparent substrate. The first dielectric layer includes zinc, tin, and aluminum. A first reflective layer is formed above the first dielectric layer. A second dielectric layer is formed above the first reflective layer. The second dielectric layer includes zinc, tin, and aluminum. A second reflective layer is formed above the second dielectric layer.

The present invention relates to low-e panels. More particularly, this invention relates to low-e panels with improved performance and methods for forming such low-e panels.

### BACKGROUND OF THE INVENTION

Low emissivity, or low-e, panels are often formed by depositing a reflective layer (e.g., silver), along with various other layers, onto a transparent (e.g., glass) substrate. The other layers typically include various dielectric and metal oxide layers, such as silicon nitride, tin oxide, and zinc oxide, to provide a barrier between the stack and both the substrate and the environment, as well as to act as optical fillers and improve the optical characteristics of the panel.

When used in, for example, windows, and depending on the particular environment (i.e., climate), it may be desirable for the low-e panels to allow visible light to pass through the window while blocking other types of solar radiation, such as infra-red. Such panels are often referred to as having a high light-to-solar gain (LSG) ratio.

Currently available low-e panels are able to achieve LSG ratios of 1.8, or even higher, by using coating with more than one reflective layer (i.e., “double silver” coatings, “triple silver” coatings, etc.) However, these coatings typically exhibit changes in, for example, optical performance (e.g., color) if they are exposed to a heat treatment, such as that often performed to temper the glass substrate. As a result, different coatings must be used depending on whether or not a heat treatment will subsequently be performed.

Some existing low-e panels, suitable for certain applications, exhibit little or no change in performance due to the heat treatment. However, these low-e panels typically only utilize a single reflective layer, and thus have relatively low LSG ratios (e.g., less than 1.5).

### BRIEF DESCRIPTION OF THE DRAWINGS

To facilitate understanding, identical reference numerals have been used, where possible, to designate identical elements that are common to the figures. The drawings are not to scale and the relative dimensions of various elements in the drawings are depicted schematically and not necessarily to scale.

The techniques of the present invention can readily be understood by considering the following detailed description in conjunction with the accompanying drawings, in which:

FIG. 1 is a cross-sectional side view of a low-e panel according to some embodiments.

FIG. 2 is a graph depicting transmittance and reflectance for low-e panels according to some embodiments.

FIG. 3 is a graph depicting transmittance and reflectance for conventional low-e panels.

FIGS. 4 and 5 are tables of data related to various performance characteristics for low-e panels according to some embodiments.

FIG. 6 is a simplified cross-sectional diagram illustrating a physical vapor deposition (PVD) tool according to some embodiments.

FIG. 7 is a flow chart illustrating a method for forming low-e panels according to some embodiments.

### DETAILED DESCRIPTION

A detailed description of one or more embodiments is provided below along with accompanying figures. The detailed description is provided in connection with such embodiments, but is not limited to any particular example. The scope is limited only by the claims, and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For the purpose of clarity, technical material that is known in the technical fields related to the embodiments has not been described in detail to avoid unnecessarily obscuring the description.

The term “horizontal” as used herein will be understood to be defined as a plane parallel to the plane or surface of the substrate, regardless of the orientation of the substrate. The term “vertical” will refer to a direction perpendicular to the horizontal as previously defined. Terms such as “above”, “below”, “bottom”, “top”, “side” (e.g. sidewall), “higher”, “lower”, “upper”, “over”, and “under”, are defined with respect to the horizontal plane. The term “on” means there is direct contact between the elements. The term “above” will allow for intervening elements.

Some embodiments provide low-e panels which exhibit very little color change from a heat treatment (e.g., to temper the glass) and improved transmission of visible light, while also providing relatively high light-to-solar gain (LSG) ratios (e.g., ˜1.8 in a double silver configuration).

In some embodiments, this is accomplished using a new material as a dielectric layer (e.g., a base layer and/or a spacer layer) within a double (or triple) silver low-e stack, which includes zinc, tin, and aluminum (e.g., zinc-tin-aluminum oxide). In some embodiments, this dielectric layer is used as a base layer formed between the substrate and the first silver layer. The base layer may have a thickness of between about 3 nm and about 40 nm. In some embodiments, the dielectric layer is also used as a base/spacer layer between the two silver layers and has a thickness of between about 50 nm and about 90 nm. The dielectric layer may also include beryllium, sodium, magnesium, potassium, calcium, and/or cadmium to adjust various performance characteristics of the low-e stack.

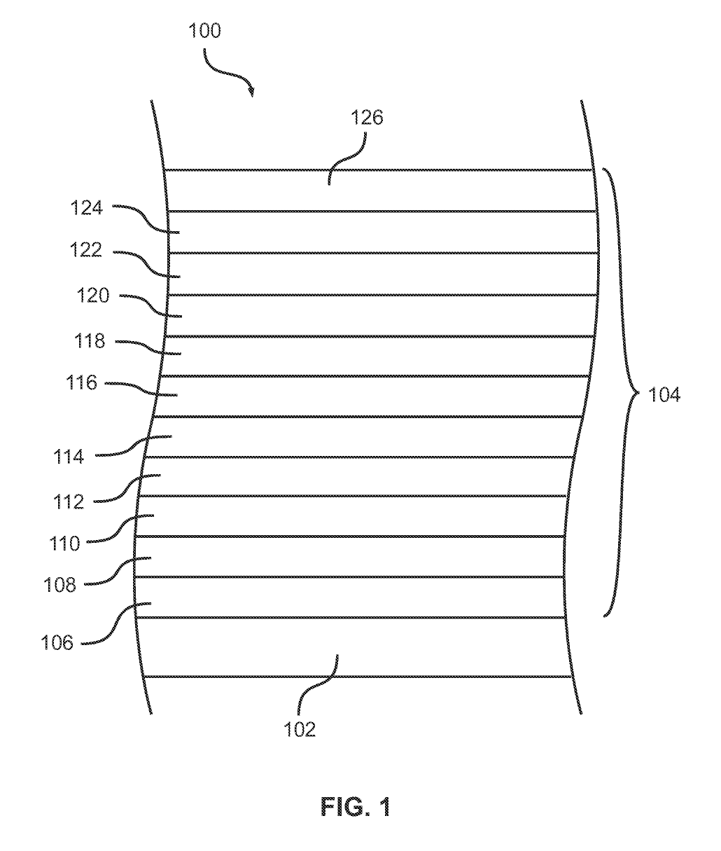

FIG. 1 illustrates a low-e panel 100 according to some embodiments. The low-e panel 100 includes a transparent substrate 102 and a low-e stack 104 formed above the transparent substrate 102. The transparent substrate 102 in some embodiments is made of a low emissivity glass, such as borosilicate glass. However, in some embodiments, the transparent substrate 102 may be made of plastic or a transparent polymer, such as polyethylene terephthalate (PET), poly(methyl methacrylate) (PMMA), polycarbonate (PC), and polyimide (PI). The transparent substrate 102 has a thickness of, for example, between about 1 and about 10 millimeters (mm). In a testing environment, the transparent substrate 102 may be round with a diameter of, for example, about 200 or about 300 mm. However, in a manufacturing environment, the transparent substrate 102 may be square or rectangular and significantly larger (e.g., about 0.5-about 4 meters (m) across).

The low-e stack 104 includes a first (or lower) protective layer 106, a first base layer 108, a first seed layer 110, a first reflective layer 112, a first barrier layer 114, a second (or upper) base layer 116, a second seed layer 118, a second reflective layer 120, a second barrier layer 122, an over-coating layer 124, and a second protective layer 126. Exemplary details as to the functionality provided by each of the layers 106-126 are provided below.

The various layers in the low-e stack 104 may be formed sequentially (i.e., from bottom to top) above the transparent substrate 102 using, for example, a physical vapor deposition (PVD) and/or reactive sputtering processing tool. In some embodiments, the low-e stack 104 is formed above the entire substrate 102. However, in some embodiments, the low-e stack 104 may only be formed above isolated portions of the transparent substrate 102. Although the layers may be described as being formed “above” the previous layer (or the substrate), it should be understood that in some embodiments, each layer is formed directly on (and adjacent to) the previously provided/formed component (e.g., layer). In some embodiments, additional layers may be included between the layers, and other processing steps may also be performed between the formation of various layers.

Still referring to FIG. 1, the first protective layer 106 is formed above the transparent substrate 102. The first protective layer 106 may be made of dielectric material, such as silicon nitride, and have a thickness of, for example, between about 5 nanometers (nm) and about 30 nm, such as about 10 nm. The first protective layer 106 may protect the other layers in the low-e stack 104 from any elements which may otherwise diffuse from the transparent substrate 102 and may be used to tune the optical properties (e.g., transmission) of the low-e stack 104 and/or the low-e panel 100 as a whole.

The first base (or dielectric) layer 108 is formed above the first protective layer 106. The first base layer 106 may include zinc, tin, aluminum, or a combination thereof. In some embodiments, the first base layer 108 is made of zinc-tin-aluminum oxide. The first base layer 108 may have a thickness of, for example, between about 3 nanometers (nm) and about 40 nm, such as about 25 nm. The first base layer 108 may be used to tune the optical properties (e.g., color, transmittance, etc.) of the low-e panel 100 as a whole, as well as to enhance silver nucleation. The material used in the first base layer 108 (e.g., zinc-tin-aluminum oxide) may also include beryllium, sodium, magnesium, potassium, calcium, cadmium, or a combination thereof (e.g., zinc-tin-aluminum-beryllium oxide) to further adjust the performance of the low-e panel 100.

The first seed layer 110 is formed above the first base layer 108. The first seed layer 110 may be made of a metal oxide and may have a thickness of, for example, between about 2 nm and about 12 nm, such as about 4 nm. In some embodiments, the first seed layer includes zinc, and the metal oxide used in the first seed layer 110 is zinc oxide. Other exemplary materials that may be used in the first seed layer 110 include tin oxide, scandium oxide, yttrium oxide, titanium oxide, zirconium oxide, hafnium oxide, vanadium oxide, niobium oxide, tantalum oxide, chromium oxide, tungsten oxide, molybdenum oxide, and combinations thereof. The first seed layer 110 may be used to enhance the deposition/growth of the first reflective layer 112 in the low-e stack 104 (e.g., enhance the crystalline structure and/or texturing of the first reflective layer 112) and increase the transmission of the low-e stack 104 for anti-reflection purposes.

The first reflective layer 112 is formed above the first seed layer 110. In some embodiments, the first reflective layer 112 is made of silver and has a thickness of, for example, between about 6 nm and about 18 nm, such as about 11.4 nm. In some embodiments, the first reflective layer 112 includes (or is made of) copper and/or gold. As is commonly understood, the first reflective layer 112 is used to reflect infra-red electro-magnetic radiation, thus reducing the amount of heat that may be transferred through the low-e panel 100.

The first barrier layer 114 is formed above the first reflective layer 112. The first barrier layer 114 may include, for example, nickel, titanium, niobium, or a combination thereof. For example, in some embodiments, the first barrier layer 114 is made of nickel-titanium-niobium, or nickel-titanium-niobium oxide. Other exemplary materials which may be used in the first barrier layer 114 include various metals and alloys (and/or oxides thereof), such as nickel-chromium, titanium, titanium-aluminum, and combinations thereof. The first barrier layer 114 may have a thickness of, for example, between about 2 nm and about 6 nm, such as about 2.5 nm. The first barrier layer 114 is used, for example, to protect the first reflective layer 112 from the processing steps used to form the subsequent layers of the low-e stack 104 and to prevent any interaction of the material of the first reflective layer 112 with the materials of the other layers of the low-e stack 104, which may result in undesirable optical characteristics of the low-e panel 100, such as poor color performance.

Still referring to FIG. 1, the second base (or dielectric) layer 116 is formed above the first barrier layer 114. The second base layer 116 may be made of the same material(s) and serve a similar purpose as the first base layer 108, as described above. The second base layer may have a thickness of, for example, between about 50 nm and about 90 nm, such as about 78 nm. In some embodiments, the second base layer 116 has a thickness that is at least twice (i.e., 2×) the thickness of the first base layer 108 (and/or the over-coating layer 124). In some embodiments, the second base layer has a thickness that is at least three times (i.e., 3×) the thickness of the first base layer 108 (and/or the over-coating layer 124). It should be understood that the second base layer 116 may also be referred to as a “spacer layer.”

The second seed layer 118 is formed above the second base layer 116. The second seed layer 118 may be made of the same material(s), have a similar thickness, and serve the same purpose as the first seed layer 110, as described above. The second reflective layer 120 is formed above the second seed layer 118. The second reflective layer 120 may be made of the same material(s) and serve the same purpose as the first reflective layer 110, as described above. The second reflective layer 120 may have a thickness of, for example, between about 6 nm and about 18 nm, such as about 14.4 nm.

The second barrier layer 122 is formed above the second reflective layer 120. The second barrier layer 122 may be made of the same material(s), have a similar thickness (e.g., about 2 nm), and serve the same purpose as the first barrier layer 114, as described above.

The over-coating layer 124 is formed above the second barrier layer 122. The over-coating layer 124 may be made of the same material(s) (e.g., a dielectric material) as the first base layer 108 and the second base layer 116 (e.g., zinc-tin-aluminum oxide). In some embodiments, the over-coating layer 124 has a thickness of, for example, between about 3 nm and about 30 nm, such as about 9 nm.

In some embodiments, the first base layer 108 has a thickness that is at least twice (i.e., 2×) the thickness of the over-coating layer 124. In some embodiments, the first base layer 108 has a thickness that is at least four time (i.e., 4×) the thickness of the over-coating layer 124. In some embodiments, the second base layer 116 has a thickness that is at least five times (i.e., 5×) the thickness of the over-coating layer 124. In some embodiments, the second base layer 116 has a thickness that is at least seven times (i.e., 7×) the thickness of the over-coating layer 124.

The over-coating layer 124 may be used to further tune the optical properties of the low-e panel 100 as a whole. Additionally, in some embodiments, the over-coating layer 124 may enhance the light-to-solar gain (LSG) ratio of the low-e panel 100.

Still referring to FIG. 1, the second protective layer (or capping layer) 126 is formed above the over-coating layer 124. The second protective layer 126 may be made of the same material(s) as the first protective layer 106 (e.g., silicon nitride). The second protective layer 126 may have a thickness of, for example, between about 5 nm and about 30 nm, such as about 20 nm. The second protective layer 126 may be used to provide additional protection for the lower layers of the stack 104 and further adjust the optical properties of the low-e panel 100. It should be noted that in some embodiments the second protective layer 126 may not be included in the low-e stack 104.

After the formation of the second protective layer 126, the low-e panel 100 may undergo a heat treatment to, for example, temper the glass within the transparent substrate 102. For example, the low-e panel 100 may be heated to a temperature of between about 600° C. and about 700° C. for about 30 minutes.

One skilled in the art will appreciate that the embodiment(s) depicted in FIG. 1 is a “double silver” low-e panel (i.e., having two reflective/silver layers). However, in some embodiments, the low-e panel 100 (or the low-e stack 104) is formed as a “single silver,” or even a “triple silver,” low-e panel (i.e., having one or three reflective/silver layers, respectively). In triple silver embodiments, other layers in the low-e stack 104, may be replicated along with the reflective layer, such as an additional base layer, seed layer, and barrier layer, while in a single silver embodiment, some of these layers may be removed, along with one of the reflective layers.

It should be noted that depending on the materials used, some of the layers of the low-e stack 104 may have some materials in common. For example, in some embodiments, the base layers 108 and 116 and the over-coating layer 124 may be made of the same material (e.g., zinc-tin-aluminum oxide).

It should also be understood that the low-e panel 100 may be a portion of (or installed in) a larger, more complex device or system, such as a low-e window. Such a window may include multiple glass substrates (or panes), other coatings (or layers), such a thermochromic coating formed on a different pane than the low-e stack, and various barrier or spacer layers formed between adjacent panes.

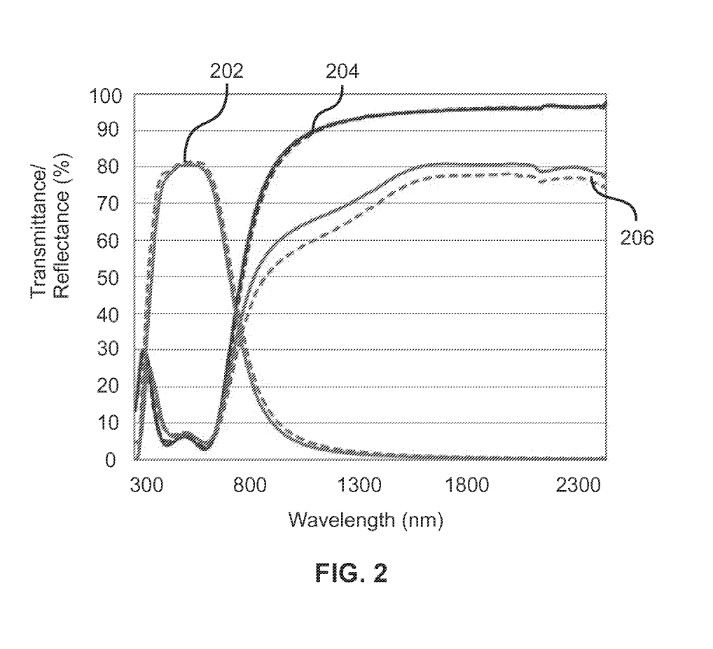

FIG. 2 graphically illustrates the transmittance (or transmission) and reflectance (or reflection), both before and after heat treatment, for low-e panels formed in accordance with some embodiments described herein (e.g., utilizing zinc-tin-aluminum base and over-coating layers). Referring now to FIG. 2, line group 202 depicts transmittance, with the solid line in line group 202 depicting the transmittance before heat treatment (i.e., as-coated) and the dashed line in line group 202 depicting the transmittance after heat treatment. As shown, the transmittance for visible light (i.e., 380-780 nm) is relative high, peaking at about 80%, and is virtually unchanged by the heat treatment.

Still referring to FIG. 2, line group 204 depicts reflectance for electro-magnetic radiation passing through the low-e panels from the side of the substrate with the low-e stack (i.e., the coating side). The solid line in line group 204 depicts this reflectance before heat treatment, and the dashed line depicts this reflectance after heat treatment. As shown, the reflectance for the coating side increases dramatically (to over 90%) for electro-magnetic radiation with wavelengths longer than that of visible light (i.e., greater than 780 nm) and is virtually unaffected by the heat treatment. Line group 206 depicts reflectance for electro-magnetic radiation passing through the low-e panels from the side of the substrate opposite the low-e stack (i.e., the substrate (or glass) side). The solid line in line group 206 depicts this reflectance before heat treatment, and the dashed line depicts this reflectance after heat treatment. As shown, the reflectance for the substrate side, though not quite as high as the coating side, also increases dramatically for electro-magnetic radiation with wavelengths longer than that of visible light and is slightly affected by the heat treatment.

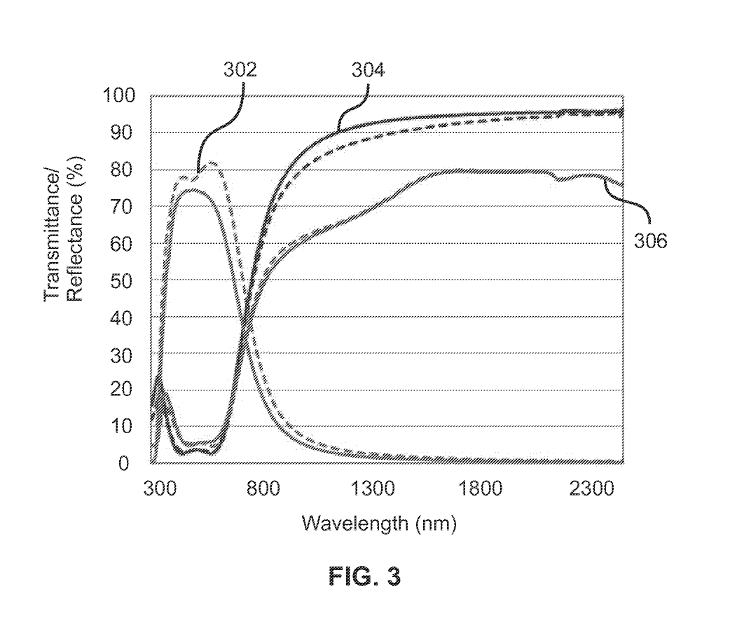

FIG. 3 graphically illustrates the transmittance (or transmission) and reflectance (or reflection), both before and after heat treatment, for low-e panels utilizing tin-aluminum oxide in the base layers and over-coating layer. Referring now to FIG. 3, line group 302 depicts transmittance, with the solid line in line group 302 depicting the transmittance before heat treatment (i.e., as-coated) and the dashed line in line group 302 depicting the transmittance after heat treatment. As shown, the transmittance for visible light (i.e., 380-780 nm) is relative high, peaking at about 80% after heat treatment. However, the heat treatment causes the transmittance to change significantly, particularly for visible light.

Still referring to FIG. 3, line group 304 depicts reflectance for electro-magnetic radiation passing through the low-e panels from the side of the substrate with the low-e stack (i.e., the coating side). The solid line in line group 304 depicts this reflectance before heat treatment, and the dashed line depicts this reflectance after heat treatment. As shown, the coating side reflectance for electro-magnetic radiation with wavelengths longer than that of visible light (i.e., greater than 780 nm) is significantly changed by the heat treatment. Line group 306 depicts reflectance for electro-magnetic radiation passing through the low-e panels from the side of the substrate opposite the low-e stack (i.e., the substrate (or glass) side). The solid line in line group 306 depicts this reflectance before heat treatment, and the dashed line depicts this reflectance after heat treatment.

Of particular interest in FIGS. 2 and 3 is that the transmittance and coating side reflectance for the low-e panels described herein are changed by the heat treatment significantly less than low-e panels using tin-aluminum oxide.

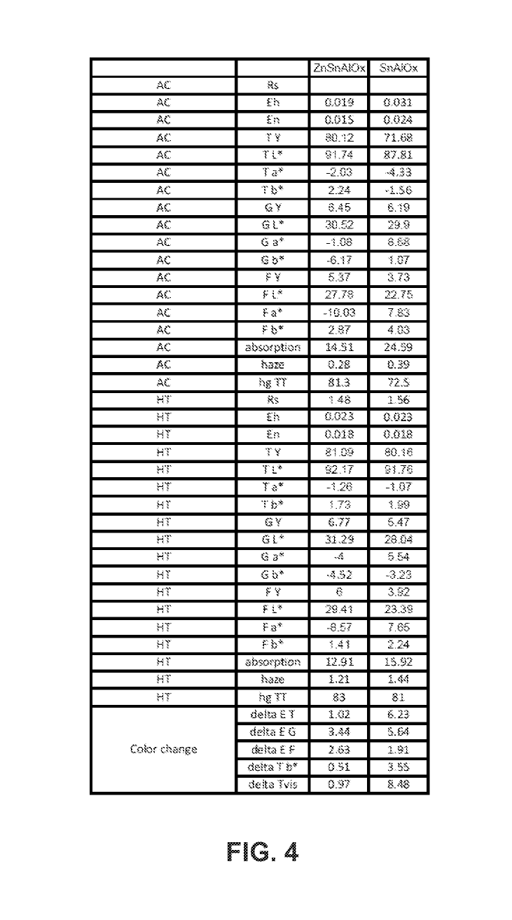

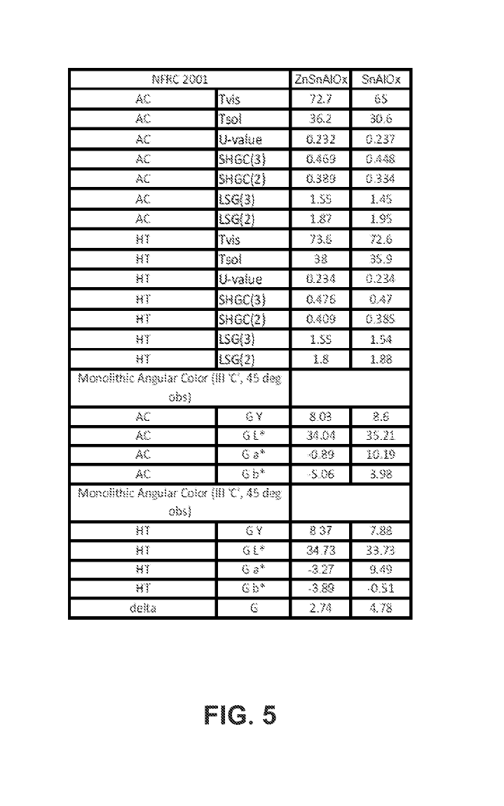

Other characteristics of the low-e panels described herein are shown in the tables depicted in FIGS. 4 and 5. “AC” indicates data for the as-coated low-e panels, and “HT” indicates data for the low-e panels after a high temperature treatment (e.g. tempering). Data are presented for both monolithic low-e panels (e.g., Monolithic Optics) and dual-pane low-e panels (e.g., IGU Optics). Due to the distribution of cones in the eye, the color observance may depend on the observer's field of view. Standard (colorimetric) observer is used, which was taken to be the chromatic response of the average human viewing through a 2 degree angle, due to the belief that the color-sensitive cones reside within a 2 degree arc of the field of view. Thus, the measurements are shown for the 2 degree Standard Observer.

The various characteristics listed in FIGS. 4 and 5 will be understood and appreciated by one skilled in the art. For example, intensity of reflected visible wavelength light, (e.g., “reflectance”) is defined for glass side “g” or for film side “f”. Intensity from glass side reflectance, (e.g., R_{g}Y), shows light intensity measured from the side of the glass substrate opposite the side of the coated layers. Intensity from film side reflectance, (e.g., R_{f}Y), shows light intensity measured from the side of the glass substrate on which the coated layers are formed. Transmittance, (e.g., TY), shows light intensity measured for the transmitted light.

The color characteristics are measured and reported herein using the CIE LAB a*, b* coordinates and scale (i.e. the CIE a*b* diagram, Ill. CIE-C, 2 degree observer). In the CIE LAB color system, the “L*” value indicates the lightness of the color, the “a*” value indicates the position between magenta and green (more negative values indicate stronger green and more positive values indicate stronger magenta), and the “b*” value indicates the position between yellow and blue (more negative values indicate stronger blue and more positive values indicate stronger yellow).

Emissivity (E) is a characteristic of both absorption and reflectance of light at given wavelengths. It can usually represented as a complement of the reflectance by the film side, (e.g., E=1−R_{f}). For architectural purposes, emissivity values can be important in the far range of the infrared spectrum, (e.g., about 2,500-40,000 nm). Thus, the emissivity value reported here includes normal emissivity (En), as measured in the far range of the infrared spectrum. Haze is a percentage of light that deviates from the incident beam greater than 2.5 degrees on the average.

Data are also shown for the difference between heat treated and as-coated low-e panels. The value ΔE* (and Δa*, Δb*, ΔY) are important in determining whether or not upon heat treatment (HT) there is matchability, or substantial matchability, of the coated panels. For purposes of example, the term Δa*, for example, is indicative of how much color value a* changes due to heat treatment. Also, ΔE* is indicative of the change in reflectance and/or transmittance (including color appearance) in a coated panel after a heat treatment. ΔE* corresponds to the CIELAB Scale L*, a*, b*, and measures color properties before heat treatment (L₀*, a₀*, b₀*) and color properties after heat treatment (L₁*, a₁*, b₁*):

ΔE*=\sqrt{(ΔL*)²+(Δa*)²+(Δb*)²}

where ΔL*=L₁*−L₀*, Δa*=a₁*−a₀*, and Δb*=b₁*−b₀*.

The color change of glass side reflection can be calculated as Rg ΔE*. The color change of light transmission can be calculated as T ΔE*, T|Δa*| and T|Δb*|. The luminance change of light transmission can be calculated as T ΔY.

Of particular interest in FIGS. 4 and 5 is that the normal emissivity and the absorption, both before and after heat treatment, is lower for the low-e panels described herein when compared to those using tin-aluminum oxide. Further, in general, the color change exhibited by the low-e panels described herein is lower. It should also be noted that the LSG ratios achieved were relatively high (e.g., 1.87 as-coated and 1.8 after heat treatment).

As an additional benefit, many of the layers in the low-e stacks described herein utilize materials used in the other layers (e.g., zinc, tin, aluminum, etc). As a result, the total number of targets required to form the low-e stack 104 may be minimized, which reduces manufacturing costs.

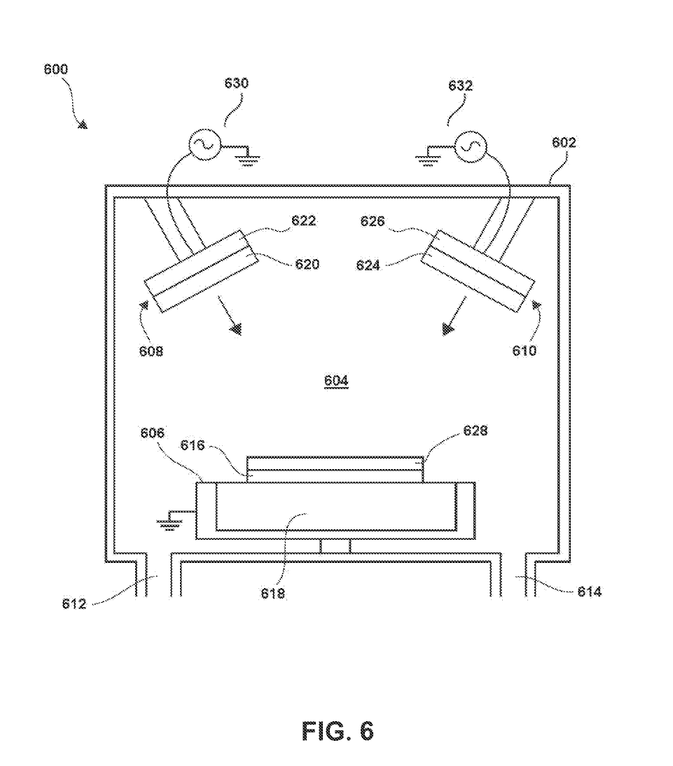

FIG. 6 provides a simplified illustration of a physical vapor deposition (PVD) tool (and/or system) 600 which may be used, in some embodiments, to form low-e panels (and/or low-e stacks), such as those described above. The PVD tool 600 shown in FIG. 6 includes a housing 602 that defines, or encloses, a processing chamber 604, a substrate support 606, a first target assembly 608, and a second target assembly 610.

The housing 602 includes a gas inlet 612 and a gas outlet 614 near a lower region thereof on opposing sides of the substrate support 606. The substrate support 606 is positioned near the lower region of the housing 602 and in configured to support a substrate 616. The substrate 616 may be a round substrate having a diameter of, for example, about 200 mm or about 300 mm. In other embodiments (such as in a manufacturing environment), the substrate 616 may have other shapes, such as square or rectangular, and may be significantly larger (e.g., about 0.5 m to about 4 m across). The substrate support 606 includes a support electrode 618 and is held at ground potential during processing, as indicated.

The first and second target assemblies (or process heads) 608 and 610 are suspended from an upper region of the housing 602 within the processing chamber 604. The first target assembly 608 includes a first target 620 and a first target electrode 622, and the second target assembly 610 includes a second target 624 and a second target electrode 626. As shown, the first target 620 and the second target 624 are oriented or directed towards the substrate 616. As is commonly understood, the first target 620 and the second target 624 include one or more materials that are to be used to deposit a layer of material 628 on the upper surface of the substrate 616.

The materials used in the targets 620 and 624 may, for example, include tin, zinc, magnesium, aluminum, lanthanum, yttrium, titanium, antimony, strontium, bismuth, silicon, silver, nickel, chromium, niobium, or any combination thereof (i.e., a single target may be made of an alloy of several metals). Additionally, the materials used in the targets may include oxygen, nitrogen, or a combination of oxygen and nitrogen in order to form oxides, nitrides, and oxynitrides. Additionally, although only two targets 620 and 624 are shown, additional targets may be used.

The PVD tool 600 also includes a first power supply 630 coupled to the first target electrode 622 and a second power supply 632 coupled to the second target electrode 624. As is commonly understood, in some embodiments, the power supplies 630 and 632 pulse direct current (DC) power to the respective electrodes, causing material to be, at least in some embodiments, simultaneously sputtered (i.e., co-sputtered) from the first and second targets 620 and 624. In some embodiments, the power is alternating current (AC) to assist in directing the ejected material towards the substrate 616.

During sputtering, inert gases (or a plasma species), such as argon or krypton, may be introduced into the processing chamber 604 through the gas inlet 612, while a vacuum is applied to the gas outlet 614. The inert gas(es) may be used to impact the targets 620 and 624 and eject material therefrom, as is commonly understood. In embodiments in which reactive sputtering is used, reactive gases, such as oxygen and/or nitrogen, may also be introduced, which interact with particles ejected from the targets (i.e., to form oxides, nitrides, and/or oxynitrides).

Although not shown in FIG. 6, the PVD tool 600 may also include a control system having, for example, a processor and a memory, which is in operable communication with the other components shown in FIG. 6 and configured to control the operation thereof in order to perform the methods described herein.

Although the PVD tool 600 shown in FIG. 6 includes a stationary substrate support 606, it should be understood that in a manufacturing environment, the substrate 616 may be in motion (e.g., an in-line configuration) during the formation of various layers described herein.

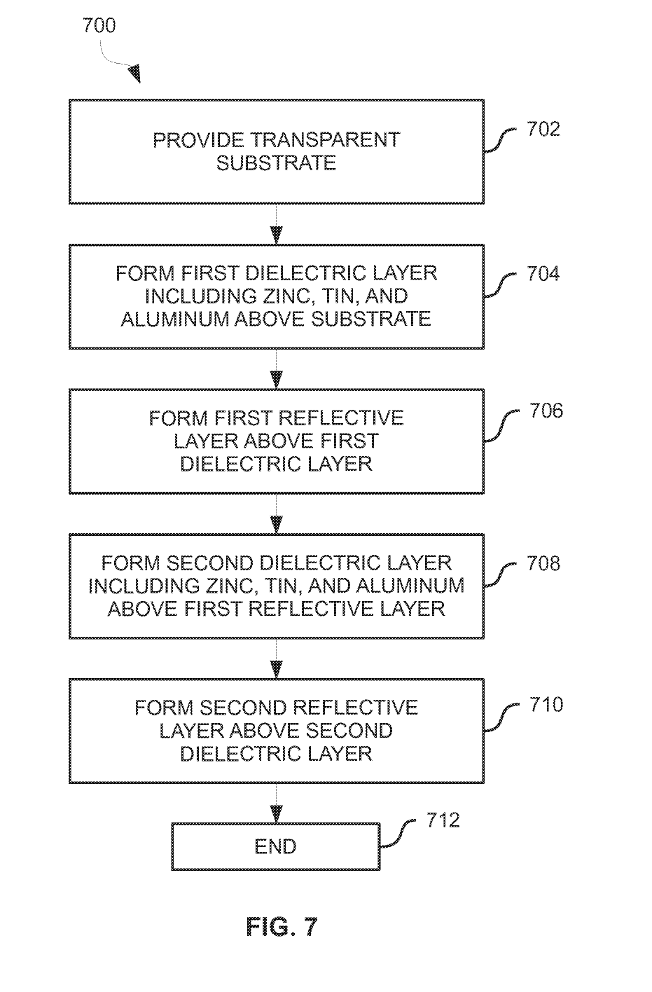

FIG. 7 is a flow chart illustrating a method 700 for forming low-e panels according to some embodiments. The method 700 begins at block 702 by providing a transparent substrate, such as the examples described above (e.g., glass).

At block 704, a first dielectric layer is formed above the transparent substrate. In some embodiments, the first dielectric layer includes zinc, tin, and aluminum. The first dielectric layer may be made of zinc-tin-aluminum oxide. At block 706, a first reflective layer is formed above the first dielectric layer. In some embodiments, the reflective layer is made of silver.

At block 708, a second dielectric layer is formed above the first reflective layer. In some embodiments, the second dielectric layer is made of the same material as the first dielectric layer (e.g., zinc-tin-aluminum oxide). At block 710, a second reflective layer is formed above the second dielectric layer.

Although not shown, the method 700 may include forming additional layers above the transparent substrate, such as those described above (e.g., seed layers, barrier layers, etc.). The method 700 may also include heating the transparent substrate and the layers formed above (e.g., to temper the glass substrate). At block 712, the method 700 ends.

Thus, in some embodiments, methods for forming a low-e panel are provided. A transparent substrate is provided. A first dielectric layer is formed above the transparent substrate. The first dielectric layer includes zinc, tin, and aluminum. A first reflective layer is formed above the first dielectric layer. A second dielectric layer is formed above the first reflective layer. The second dielectric layer includes zinc, tin, and aluminum. A second reflective layer is formed above the second dielectric layer.

In some embodiments, methods for forming a low-e panel are provided. A transparent substrate is provided. A first dielectric layer is formed above the transparent substrate. The first dielectric layer includes zinc-tin-aluminum oxide. A first seed layer is formed above the first dielectric layer. The first seed layer includes zinc. A first reflective layer is formed above the first seed layer. A second dielectric layer is formed above the first reflective layer. The second dielectric layer includes zinc-tin-aluminum oxide. A second seed layer is formed above the second dielectric layer. The second seed layer includes zinc. A second reflective layer is formed above the second seed layer.

In some embodiments, low-e panels are provided. The low-e panels include a transparent substrate. A first dielectric layer is formed above the transparent substrate. The first dielectric layer includes zinc, tin, and aluminum. A first reflective layer is formed above the dielectric layer. A second dielectric layer is formed above the above the first reflective layer. The second dielectric layer includes zinc, tin, and aluminum. A second reflective layer is formed above the second dielectric layer.

In some embodiments, methods for forming a low-e panel are provided. A transparent substrate is provided. A first dielectric layer is formed above the transparent substrate. The first dielectric layer includes zinc, tin, and aluminum. A first seed layer is formed above the first dielectric layer. The first seed layer includes zinc. A first reflective layer is formed above the first seed layer. A first barrier layer is formed above the first reflective layer. The first barrier layer includes nickel, titanium, and niobium. A second dielectric layer is formed above the first barrier layer. The second dielectric layer includes zinc, tin, and aluminum. A second seed layer is formed above the second dielectric layer. The second seed layer includes zinc. A second reflective layer is formed above the second seed layer. A thickness of the second dielectric layer is at least twice a thickness of the first dielectric layer.

In some embodiments, methods for forming a low-e panel are provided. A transparent substrate is provided. A first dielectric layer is formed above the transparent substrate. The first dielectric layer includes zinc, tin, and aluminum. A first seed layer is formed above the first dielectric layer. The first seed layer includes zinc. A first reflective layer is formed above the first seed layer. A first barrier layer is formed above the first reflective layer. The first barrier layer includes nickel, titanium, and niobium. A second dielectric layer is formed above the first barrier layer. The second dielectric layer includes zinc, tin, and aluminum. A second seed layer is formed above the second dielectric layer. The second seed layer includes zinc. A second reflective layer is formed above the second seed layer. A third dielectric layer is formed above the second reflective layer. The third dielectric layer includes zinc, tin, and aluminum. A thickness of the second dielectric layer is at least twice a thickness of the first dielectric layer and a thickness of the third dielectric layer.

In some embodiments, low-e panels are provided. The low-e panels include a transparent substrate. A first dielectric layer is formed above the transparent substrate. The first dielectric layer includes zinc, tin, and aluminum. A first seed layer is formed above the first dielectric layer. The first seed layer includes zinc. A first reflective layer is formed above the first seed layer. A first barrier layer is formed above the first reflective layer. The first barrier layer includes nickel, titanium, and niobium. A second dielectric layer is formed above the first barrier layer. The second dielectric layer includes zinc, tin, and aluminum. A second seed layer is formed above the second dielectric layer. The second seed layer includes zinc. A second reflective layer is formed above the second seed layer. A thickness of the second dielectric layer is at least twice a thickness of the first dielectric layer.

Although the foregoing examples have been described in some detail for purposes of clarity of understanding, the invention is not limited to the details provided. There are many alternative ways of implementing the invention. The disclosed examples are illustrative and not restrictive.

What is claimed is:

1-15. (canceled)

16. A low-e panel comprising:
a transparent substrate;
a first dielectric layer formed above the transparent substrate, wherein the first dielectric layer comprises zinc, tin, and aluminum;
a first seed layer formed above the first dielectric layer, wherein the first seed layer comprises zinc;
a first reflective later formed above the first seed layer;
a first barrier layer formed above the first reflective layer, wherein the first barrier layer comprises nickel, titanium, and niobium;
a second dielectric layer formed above the first barrier layer, wherein the second dielectric layer comprises zinc, tin, and aluminum;
a second seed layer formed above the second dielectric layer, wherein the second seed layer comprises zinc; and
a second reflective layer formed above the second seed layer,
wherein a thickness of the second dielectric layer is at least twice a thickness of the first dielectric layer, and
wherein at least one of the first dielectric layer and the second dielectric layer further comprises at least one of beryllium, sodium, magnesium, potassium, calcium, cadmium, or a combination thereof.

17. The low-e panel of claim 16, wherein the thickness of the second dielectric layer is at least three time the thickness of the first dielectric layer.

18. The low-e panel of claim 17, wherein each of the first dielectric layer and the second dielectric layer comprises at least one of zinc-tin-aluminum-beryllium oxide, zinc-tin-aluminum-sodium oxide, zinc-tin-aluminum-magnesium oxide, zinc-tin-aluminum-potassium oxide, zinc-tin-aluminum-calcium oxide, zinc-tin-aluminum-cadmium oxide, or a combination thereof.

19. The low-e panel of claim 18, wherein the first dielectric layer has a thickness of between about 3 nanometers (nm) and about 40 nm.

20. The low-e panel of claim 19, wherein the second dielectric layer has a thickness of between about 50 nanometers (nm) and about 90 nm.

21. The low-e panel of claim 20, wherein each of the first dielectric layer and the second dielectric layer consists of at least one of zinc-tin-aluminum-beryllium oxide, zinc-tin-aluminum-sodium oxide, zinc-tin-aluminum-magnesium oxide, zinc-tin-aluminum-potassium oxide, zinc-tin-aluminum-calcium oxide, zinc-tin-aluminum-cadmium oxide, or a combination thereof.

22. The low-e panel of claim 21, wherein each of the first seed layer and the second seed layer consists of zinc oxide, the first seed layer is formed directly on the first dielectric layer, and the second seed layer is formed directly on the second dielectric layer.

23. The low-e panel of claim 22, wherein each of the first reflective layer and the second reflective layer consists of silver, the first reflective layer is formed directly on the first seed layer, and the second reflective layer is formed directly on the second seed layer.

24. The low-e panel of claim 23, wherein the first barrier layer consists of nickel-titanium-niobium or nickel-titanium-niobium oxide and is formed directly on the first reflective layer, and wherein the second dielectric layer is formed directly on the first barrier layer.

25. A low-e panel comprising:
a transparent substrate;
a first dielectric layer formed above the transparent substrate, wherein the first dielectric layer comprises zinc, tin, and aluminum and at least one of beryllium, sodium, magnesium, potassium, calcium, cadmium, or a combination thereof;
a first seed layer formed above the first dielectric layer, wherein the first seed layer comprises zinc;
a first reflective later formed above the first seed layer;
a first barrier layer formed above the first reflective layer, wherein the first barrier layer comprises nickel, titanium, and niobium;
a second dielectric layer formed above the first barrier layer, wherein the second dielectric layer comprises zinc, tin, and aluminum and at least one of beryllium, sodium, magnesium, potassium, calcium, cadmium, or a combination thereof;
a second seed layer formed above the second dielectric layer, wherein the second seed layer comprises zinc; and
a second reflective layer formed above the second seed layer,
wherein a thickness of the second dielectric layer is at least twice a thickness of the first dielectric layer.

26. The low-e panel of claim 25, wherein each of the first dielectric layer and the second dielectric layer comprises at least one of zinc-tin-aluminum-beryllium oxide, zinc-tin-aluminum-sodium oxide, zinc-tin-aluminum-magnesium oxide, zinc-tin-aluminum-potassium oxide, zinc-tin-aluminum-calcium oxide, zinc-tin-aluminum-cadmium oxide, or a combination thereof.

27. The low-e panel of claim 26, wherein each of the first dielectric layer and the second dielectric layer consists of at least one of zinc-tin-aluminum-beryllium oxide, zinc-tin-aluminum-sodium oxide, zinc-tin-aluminum-magnesium oxide, zinc-tin-aluminum-potassium oxide, zinc-tin-aluminum-calcium oxide, zinc-tin-aluminum-cadmium oxide, or a combination thereof.

28. The low-e panel of claim 27, wherein each of the first seed layer and the second seed layer consists of zinc oxide, the first seed layer is formed directly on the first dielectric layer, and the second seed layer is formed directly on the second dielectric layer.

29. The low-e panel of claim 28, wherein each of the first reflective layer and the second reflective layer consists of silver, the first reflective layer is formed directly on the first seed layer, and the second reflective layer is formed directly on the second seed layer.

30. The low-e panel of claim 29, wherein the first barrier layer consists of nickel-titanium-niobium or nickel-titanium-niobium oxide and is formed directly on the first reflective layer, and wherein the second dielectric layer is formed directly on the first barrier layer.
